(19) United States
(12) Patent Application Publication
(10) Pub. No.: US 2007/0293612 A1
(43) Pub. Date: Dec. 20, 2007

(54) Stabilizer Composition for Halogen-Containing Thermoplastic Resin Compositions

(76) Inventor: Walter Reith, Egenhofen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/579,270

(22) PCT Filed: Nov. 10, 2004
(86) PCT No.: PCT/EP04/12726

§ 371 Date: Mar. 12, 2007

(30) Foreign Application Priority Data
Nov. 12, 2003 (DE) 103 52 762.1

(51) Int. Cl. C08K 5/32; C09K 15/02; C09K 15/20

(52) U.S. Cl. 524/259; 252/400.61

(57) ABSTRACT

The present invention relates to a stabilizer composition for thermoplastic resin compositions, in particular for resin compositions based on polyvinyle chloride (PVC), that comprises calcium hydroxide or calcium oxide or a mixture thereof, at least one hydroxyl-group-containing isocyanurate and less than 0.5 phr of β-diketones, based on the thermoplastic resin to be stabilized or the thermoplastic resins to be stabilized.

The present invention relates to a calcium (Ca) and zinc (Zn) containing stabilizer composition for thermoplastic resin compositions, in particular for resin compositions based on polyvinyle chloride (PVC).

Halogen-containing polymers are subjected to a multiplicity of use and ambience induced, chemical decomposition reactions, for example by exposure to electro-magnetic radiation or heat or a combination of two or more external influences, which can bring forth detrimental impairment of the usage properties or which already cause problems during the processing. During the decomposition of halogenated polymers, especially in the case of PVC, hydrochloric acid is often generated, which is eliminated from the polymer strand, resulting in a discoloured, unsaturated plastic having colour-imparting polyene sequences.

A particular problem in that case is that halogen-containing polymers exhibit the Theological conditions, which are necessary for the processing, only at a relatively high processing temperature. At such temperatures, however, in the case of unstabilized polymers, the polymer already begins to undergo significant decomposition, which results both in the undesirable colour change described above and in a change of the material properties. Furthermore, the hydrochloric acid, that is freed at such a processing temperature from non-stabilized halogen-containing polymers, can lead to significant a corrosion of the processing apparatus. This process plays a particular role when, during the processing of such halogenated polymers to form moulded articles, for example, by extrusion, the production is interrupted and the polymer compound remains in the extruder for a prolonged period. During that period, the above-mentioned decomposition reactions may occur, so that the charge in the extruder is rendered unusable and the extruder may possibly be damaged.

Furthermore, polymers, which are subjected to such a decomposition, tend to built up adhesions in the processing apparatus, which are only hardly to remove and therefore detrimentally influence the production process in view of economic efficiency as well as optionally detrimentally influence the product quality.

To solve the mentioned problems, for the processing, so-called stabilizers compounds, which preferably inhibit the mentioned above decomposition reactions to a large extent, are generally added to halogen-containing polymers. Normally, these stabilizers are solids, which are added before the processing to the polymer to be processed.

Due to the great demands, which are demanded of those moulded articles, and due to their good stabilizing properties, heavy-metal-containing stabilizers are generally used for the production of moulded articles of PVC-U, such as window profiles, industrial profiles, tubes and plates. As the application of heavy metals as lead and cadmium for stabilizing PVC is perceived as being detrimental in view of environmental reasons, attempts were made to replace those stabilizers to an increasing degree by physiologically benign stabilizing systems, which are based on calcium and zinc compounds (Ca/Zn stabilizers). However, these stabilizers mostly give the moulded articles, which is stabilized therewith, a remarkably lower thermostability.

The known Ca/Zn stabilizing systems are therefore, in particular for white moulded articles of PVC-U for the use outside as PVC window profiles, no more than insufficient in view of thermostability.

The application of hydrotalcites of the general formula Mg₁₋ₓAlₓ(OH)₂A_{x/n}ⁿ⁻*mH₂O for the inhibition of the decomposition of thermoplastic resins is known from DE—A 30 19 632. It has been shown, that the compounds listed herein, to not solitarily achieve the desired quality in view of thermal stability.

Also other stabilizer compositions of the hydrotalcite type, as they are described in EP 0 189 899 B1 as [(M₁²⁺)_{y1}(M₂²⁺)_{y2}]₁₋ₓMₓ³⁺(OH)₂A_{x/n}ⁿ⁻*m H₂O, can not just insufficiently satisfy the high demands on thermostability of PVC containing compositions.

The application of calcium hydroxide as stabilizer for PVC is described for example in DE 29 35 689 A1, the combination of overbasic earth alkali carboxylates as zeolites, calcium hydroxide and perchlorates is known from EP 0 394 547 B1. However, the combinations described therein are only suitable for the application in PVC-P for the use inside. This is also effective for the compositions mentioned in DE 40 31 401 A1.

A combination of various, finely dispersed, calcium compounds, that are coated with calcium stearate is suggested to be applied as PVC stabilizer in DD 298 799 A.

However, the solution approaches disclosed according to the documents cited above show no satisfying stabilization in case of high loads.

The WO 99/55777 describes a stabilizer composition for halogen-containing thermoplastic resin compositions. According to this document, a mixture of optionally surface modified calcium hydroxide and/or calcium oxide and a hydroxyl-group containing isocyanurate is suggested for stabilization. In view of the preceding prior art, the compositions described therein already effectuate an enhancement of the stability of halogen-containing resin compositions, however the performance of accordingly stabilized compositions in some processing situations is not yet totally satisfying. Moreover, the surfaces of profiles produced from such a composition frequently show irregularities, which are detrimental to the appearance of the profile. Furthermore, during the processing, the rheology of the compositions leaves in some cases something to be desired. In particular, if a small content on stabilizer constituents is emphasized, in some cases the stabilizing results provide the opportunity of enhancement of the stabilizing results.

In general, processing aids are indispensable for the aimed adjustment of the properties during and after the processing of halogen-containing thermoplastic polymers. Beside the aspect of not negligible costs, which have to be expended for those processing aids, the influence by stabilizers and processing aids on the whole scope of properties of a halogen-containing thermoplastic polymer is more frequently in the focus of the processing industry. Therefore, stabilizers for the processing of halogen-containing polymers are demanded to an increasing extent, which effect, also in small application quantities, simultaneously excellent processing properties and a stability, which is adequate to the particular requirements. In fact, stabilizer systems that achieve good results in specific fields of stabilization or of rheologic influence are known from the prior art, however, the simultaneous adjustment of good stabilizing and processing properties often results in the application of a mixture of stabilizers and further processing aids, whose application quantity is too high in respect of the aimed results.

The object of the invention is therefore to provide a stabilizer composition for halogen-containing thermoplastic resins, which provides a thermostability that is satisfactory compared to known formulations. A further object of the invention is to provide a stabilizer composition for halogen-containing thermoplastic resins, which provides an enhanced color stabilization compared to known formulations. Furthermore, the object of the invention is to provide a stabilizer composition for halogen-containing thermoplastic resins that has an improved initial gel formation behavior compared to known formulations. Further on, the invention is based on the object to provide a stabilizer composition for halogen-containing thermoplastic resins that is especially suitable for the application in PVC-U for the use outside. Moreover, the invention underlies the object to provide a stabilizer composition for halogen-containing thermoplastic resins that shows no “plate-out” (fouling in the extruder or in the caliber) and that is applicable in numerous different machines. Furthermore, the invention is based on the object to provide a stabilizer composition for halogen-containing thermoplastic resins that can be applied in numerous different formulations, i.e. with different types of PVC, different types of chalk, different impact modifiers as well as in different dosages of those additives.

According to the invention, the object is solved by a stabilizer composition for halogen-containing thermoplastic resins, comprising
(a) calcium hydroxide and/or calcium oxide, which can optionally be surface modified,
(b) one hydroxyl-group-containing isocyanurate and
(c) at least one β-diketone.

Therefore, the object of the present invention is a stabilizer composition for stabilizing halogen-containing thermoplastic resins, comprising
(a) calcium hydroxide or calcium oxide or a mixture thereof,
(b) at least one hydroxyl-group-containing isocyanurate and
(c) at least one β-diketone or a salt of a β-diketone or a mixture thereof,

whereas the weight content of the constituent (c) is less than 0.5 phr, based on the thermoplastic resin to be stabilized or the thermoplastic resins to be stabilized.

At to the description of stabilizer compositions for halogen-containing polymers, amounts are prevalently given to that effect, that the amount of ingredients is given as subsequent charging amount within the blend with the polymer to be stabilized. In this manner, it is achieved that the amount has a reference quantity in view of the stated effect in the polymer.

However, the weight content of the different constituents in a stabilizer composition according to the invention can also be based on the overall weight of the stabilizer composition itself. Thus, it is achieved that a reference quantity in the composition itself is generated, whereas the selected composition is especially well suitable for the application described according to the invention, because its properties collectively support the application in view of the reference quantity of the polymer to be stabilized.

That is to say, that a composition according to the invention, which comprises the ingredients in the amounts stated below, for example, by the application in an amount that complies with the above specified reference quantities upon the polymers to be stabilized, provides especially good stabilizing results due to the selection of the amount of ingredients. Therefore, the present invention also relates to a stabilizer composition for stabilizing halogen-containing thermoplastic resins, comprising
(a) calcium hydroxide or calcium oxide or a mixture thereof,
(b) at least one hydroxyl-group-containing isocyanurate and
(c) at least one β-diketone or a salt of a β-diketone or a mixture thereof,

whereas the weight content of the constituent (c) is less than 2.369% by weight, based on the total weight of the stabilizer composition.

Calcium oxide or calcium hydroxide or a mixture thereof are suitable as constituent (a) in substantially any form. Thereby, calcium oxide or calcium hydroxide are preferably applied in powder form. Suitable powders can substantially have any size distribution of the powder particles, as long as the stabilizing result is not or not substantially more than according to circumstances tolerable deteriorated. This is accordingly applied to the BET surface of the applied particles.

Within the scope of the present invention, for example calcium oxide or calcium hydroxide particles are applied, which have a D50 value of the particle size distribution of about 30 μm or less, in particular of less than about 10 μm or less than about 5 μm. The secondary particle size (size of the agglomerate) should not exceed a value of about 40 μm. The secondary particle size is preferably less than about 40 μm, in particular less than about 30 μm or less than about 20 μm.

The calcium oxide or calcium hydroxide particles can optionally be surface modified in a manner known by a person skilled in the art. Particles that are surface modified with stearic acid or 12-hydroxystearic acid are especially suitable.

According to the invention, it has turned out that particularly good results can be achieved, if the stabilizer composition comprises the constituent (a) in an amount of 0.01 to 2 phr, based on the thermoplastic resin to be stabilized or on the thermoplastic resins to be stabilized. Particularly suitable proportions of constituent (a) are for example in a range of about 0.05 to about 1.0 phr, or within a range of about 0.08 to about 0.8 phr. For example amounts of about 0.1 to about 0.5 phr, for example of about 0.15 to about 0.45 phr or about still in 0.2 to about 0.4 phr or about 0.25 to about 0.35 phr or about 0.28 to about 0.32 phr, are also suitable.

Within the scope of a preferred embodiment of the present invention, the content of constituent (a) is about 0.05 to 0.3299 phr, based on the thermoplastic resin to be stabilized or the thermoplastic resins to be stabilized.

The constituent (b) is comprised in a stabilizer composition according to the invention in an amount of about 0.01 to about 1 phr, based on the thermoplastic resin to be stabilized or the thermoplastic resins to be stabilized. Particularly suitable amounts are for example within a range of about 0.03 to about 0.9 phr or about 0.05 to about 0.7 phr or about 0.08 to about 0.5 phr or about 0.1 to about 0.4 phr or about 0.12 to about 0.25 phr or about 0.15 to about 0.2 phr. The content of constituent (b) is preferably about 0.05 to 0.299 phr, based on the thermoplastic resin to be stabilized or the thermoplastic resins to be stabilized.

In principle, all isocyanurates, which have at least one OH group are suitable as constituent (b) within the scope of the present invention. However, within the scope of a preferred embodiment of the present invention, isocyanurates, which comprise at least two OH groups, are applied. However, within the scope of the present invention, the application of isocyanurates, which have three OH groups, are particularly preferred.

Within the scope of a particularly preferred embodiment of the present invention, the hydroxyl-group-containing isocyanurate is selected from compounds of the general formula (I)

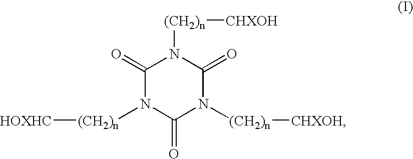

whereas the groups X and the indices n are identical or different and n is an integer from 0 to 5 and X is a hydrogen atom or a linear or branched alkyl group having from 1 to 6 carbon atoms.

Thereby, special preference is given to tris(hydroxyethyl)isocyanurate (in the following indicated as THEIC) as well as hindered phenolic isocyanurates according to EP 0 685 516 B1, to whose disclosure, concerning corresponding hindered phenolic isocyanurates, reference is expressly made and whose disclosure, concerning such isocyanurates, is regarded as part of the disclosure of the present text.

Besides the constituent (a) and (b), a stabilizer composition according to the invention comprises furthermore at least one β-diketone or a salt of a β-diketone or a mixture thereof. That is to say that a composition according to the invention can comprise for example a β-diketone or a mixture of two or more β-diketones, or a salt of a β-diketone or a mixture of two or more salts of a β-diketone or a mixture of two or more salts of two or more β-diketones or a mixture of a β-diketone and a salt of a β-diketone or a mixture of two or more β-diketones and a salt of a β-diketone or a mixture of two or more β-diketones and a mixture of two or more salts of a β-diketone or a mixture of two or more β-diketones and a mixture of two or more salts of two or more β-diketones or a mixture of a β-diketone and a mixture of two or more salts of a β-diketone or a mixture of a β-diketone and a mixture of two or more salts of two or more β-diketones.

As β-Diketones there are suitable for example compounds of the general formula (II)

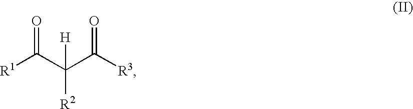

whereas R¹ and R³ are each independently of the others an unsubstituted or substituted linear or branched alkyl or alkenyle group having from 1 to 30 carbon atoms, an unsubstituted or substituted aralkyl group having from 7 to 31 carbon atoms, an unsubstituted or substituted aryl or heteroaryl group having from 3 to 14 carbon atoms in the ring, an unsubstituted or substituted cycloalkyl group having from 3 to 18 carbon atoms or R¹ or R³ can, dependently of the other, each be O—R¹oder HN—R¹ and R² is O—R¹ or COOH or an unsubstituted or substituted linear or branched alkyl group having from 1 to 24 carbon atoms or R¹ or R³ or R¹ and R³ respectively form together with R² an unsubstituted or substituted cycloaliphatic or heterocycloaliphatic ring having, each independently from the other, in each case from 3 to 18 carbon atoms, as well as their salts.

In general, all substituents are suitable as substituent, which do not or do not more than tolerable detrimentally affect the effect with respect to the stabilization and processing properties of the polymers to be stabilized, which is achieved by means of the β-diketones. Suitable substituents are for example OH groups, keto groups, halogen atoms such as F, Cl or Br, alkyl groups, cycloalkyl groups or aryl groups.

Suitable compounds, that comply with the general formula II and that are applicable within the scope of the present invention, are for example diacetylmethane(acetyl acetone), propionylacetylmethane, butyroylacetylmethane, pentanoylace-tylmethane, hexanoylacetylmethane, heptanoylacetylmethane, triacetylmethane, benzoylacetylmethane, dimedone, acetyltetralone, palmitoyltetralone, stearoyltetralone, benzoyltetralone, 2-acetylcyclohexanone, 2-benzoylcyclohexanone, 2-acetylcyclohexanon-1,3-dione, bis(4-methylbenzoyl)methane, bis(2-hydroxybenzoyl)methane, tribenzoylmethane, diacetylbenzoylmethane, stearoylbenzoylmethane, palmitoylbenzoylmethane, diacetylbenzoylmethane, dibenzoylmethane, 4-methoxybenzoylbenzoylmethane, bis(3,4-methylendioxybenzoyl)methane, benzoylacetyloctylmethane, benzoylacetylphenylmethane, stearoyl-4-methoxybenzoylmethane, bis(4-tertbutylbenzoyl)methane, benzoylacetylethylmethane, benzoyltrifluoroacetyl-methane, distearoylmethane, stearoylacetylmethane, palmitoylacetylmethane, lauroylacetylmethane, benzoylformylmethane, acetylformylmethylmethane, benzoylacetylphenylmethane, bis(cyclohexanoyl(2))methane and the like.

For example, the salts of alkaline metals, earth alkali metals or appropriate transition metals are suitable as salts of these compounds. Suitable salts are, for example, the salts of the above mentioned compounds with Li, Na, K, Ba, Ca, Mg, Zn, Zr, Ti, Sn or Al. Of the salts of the compounds of the general formula II, the salts with Ca or Zn or mixtures thereof are particularly preferred

Thereby, within the scope of the present invention, special preference is given to salts of β-diketones having a melting point of less than about 150° C., in particular having a melting point of less than about 120° C., for example calcium acetyl acetonate or zinc acetyl acetonate.

Furthermore, it turned out as being advantageous within the scope of the present invention, if a composition according to the present invention comprises a mixture of two or more β-diketones, for example 2, 3 or 4 β-diketones. Thereby, within the scope of the present invention, special preference is given to such a mixture comprising at least one β-diketone that is not present in form of a salt and at least one β-diketone that is present in form of a salt. Thereby, special preference is given to combinations of calcium acetylacetonate or zinc acetylacetonate or a mixture thereof with a β-diketone that comprises at least one aromatic group and one aliphatic group having at least 12 carbon atoms, for example the combination of calcium acetylacetonate or zinc acetylacetonate with benzoylstearoylmethane.

Within the scope of the present invention it turned out that, in contradiction to the originally from the prior art deducible opinion, the combination of the constituents (a), (b) and (c) achieves good stabilizing results even if the proportion of the constituent (c) of the composition, based on the polymer to be stabilized, is less than 0.5 phr, for example about 0.45 or less or about 0.4 or less or about 0.35 or less or about 0.33 or less. Within the scope of a preferred embodiment of the present invention, the proportion of constituent (c) is about 0.01 to about 0.3 phr, based on the thermoplastic resin to be stabilized or the thermoplastic resins to be stabilized, for example about 0.05 to about 0.29 or about 0.08 to about 0.25 or about 0.1 to about 0.24 phr, in each case based on the halogen-containing polymer that is envisaged for stabilization.

Within the scope of a further preferred embodiment of the present invention, the stabilizer composition according to the invention comprises calcium acetylacetonate or zinc acetylacetonate or a mixture thereof in an amount of about 0.001 to about 0.3 phr, based on the thermoplastic resins to be stabilized. Special preference is given to amounts of the content of calcium acetylacetonate or zinc acetylacetonate or a mixtures thereof that are for example in a range of about 0.01 to about 0.29 or about 0.05 to about 0.28 or about 0.1 to about 0.27 or about 0.12 to about 0.26 or about 0.15 to about 0.24 phr, based on the halogen-containing polymer to be stabilized.

According to another embodiment of the present invention, a stabilizer composition according to the invention comprises calcium acetylacetonate or zinc acetylacetonate or a mixture thereof in an Amount of about 0.001 to about 10% by weight or about 0.005 to about 5% by weight, based on the total weight of the stabilizer composition. Special preference is given to amounts of the content of calcium acetylacetonate or zinc acetylacetonate or a mixture thereof, that are in a range of about 0.005 to about 3 or about 0.005 to about 1.5% by weight or about 0.01 to about 1.3 or about 0.05 to about 0.8% by weight, based on the total weight of the stabilizer composition.

Within this context, it is furthermore advantageous if the ratio of β-diketones to salts of β-diketones is within the range of about 1:10 to about 10:1. Preferred ratios are, for example, within a range of about 1:5 to about 5:1 or about 1:2 to about 2:1 or about 1:1 to about 2:1, whereas the ratio of about 2:1 is preferred within the scope of the present invention.

The content of constituent (a), (b) and (c) of the stabilizer composition is about 0.5 to about 80% by weight, based on the total stabilizer composition. Preferably, the content of the constituents (a), (b) and (c) is about 1 to about 50% by weight, for example about 2 to about 20% by weight.

Thereby, the proportion of constituent (a) in the stabilizer composition is for example in the range of about 0.01 to about 30% by weight or in the range of about 0.05 to about 15% by weight or in the range of about 0.1 to about 10% by weight or in the range of about 0.15 to about 5% by weight or in the range of about 0.2 to 4% by weight or in the range of about 0.25 to 3% by weight or in the range of about 0.5 to 2.6% by weight, in each case based on the total weight of the stabilizer composition.

The proportion of constituent (b) in the stabilizer composition is for example in the range of about 0.01 to about 30% by weight or in the range of about 0.01 to about 20% by weight or in the range of about 0.01 to about 10% by weight or in the range of about 0.05 to about 11% or in the range of about 0.05 to about 6% by weight or in the range of about 0.1 to about 5% by weight or in the range of about 0.15 to about 4% by weight or in the range of about 0.2 to 3% by weight or in the range of 0.25 to 2% by weight or in the range of about 0.5 to 1.6% by weight, in each case based on the total weight of the stabilizer composition.

The proportion of constituent (c) in the stabilizer composition is for example in the range of about 0.01 to about 30% by weight or in the range of about 0.01 to about 20% or in the range of about 0.01 to about 10% by weight or in the range of about 0.05 to about 8% or in the range of about 0.05 to about 5% by weight or in the range of about 0.1 to about 3% by weight or in the range of about 0.05 to less than 2.369% or in the range of about 0.1 to 2.45% by weight or in the range of 0.1 to 1.4% by weight or in the range of about 0.1 to 1.25% by weight, in each case based on the total weight of the stabilizer composition.

Whereas a content of a stabilizer composition according to the invention of the above mentioned constituents (a), (b) and (c) already achieves surprisingly good stabilizing results within the above mentioned limits, it has furthermore turned out as being advantageously if the stabilizer composition according to the invention comprises a hydrotalcite or a mixture of two or more hydrotalcites.

In general, each type of hydrotalcite is suitable within the scope of the present invention, which shows at least no or in any case no substantial detrimental influence in respect of the processing properties and/or the stabilization of a halogen-containing polymer within the scope of a stabilizer composition according to the invention. For example hydrotalcites such as they are described in the documents WO 96/02465 A1 (in particular p. 3 to 7 and examples), EP 0 189 899 (in particular p. 10-15, Table 2 to 10), DE 38 43 581 (in particular p. 4), U.S. Pat. No. 4,883,533 (in particular column 2-4, Examples), EP 0 407 139 A2 (in particular p. 2-3, Examples), DE 40 31 818 A1 (in particular p. 2-3), DE 41 10 835 A1 (in particular column 2-5, Examples), DE 41 17 034 A1 (in particular p. 2-6, Examples), EP 0 522 810 A2 (in particular p. 2-3), DE 44 39 934 A1 (in particular p. 2-3, Examples) and U.S. Pat. No. 5,352,723 (in particular column 2-3, Examples). Reference is expressly made to the disclosure of the above mentioned documents, in particular to the disclosure of the mentioned passages, whereas the corresponding disclosure of the documents is regarded as part of the disclosure of the present text.

Thereby, according to the invention it was shown that in particular a content of hydrotalcites that is within relatively narrow limits, which are within a range of about 0.05 to about 0.25 phr, based on the amount of halogen-containing polymer to be stabilized, facilitates the low content of constituent (a), (b) and (c) according to the invention in respect of a particularly good processability and good stabilizing results. Within the scope of a preferred embodiment of the present invention, a stabilizer composition according to the invention comprises thereby a hydrotalcite or a mixture of two or more hydrotalcites in an amount of about 0.08 to about 0.18 phr, for example in an amount of about 0.1 to about 0.15 phr.

Furthermore, it turned out as being advantageously if the stabilizer composition according to the invention comprises at least one zinc salt of an organic carboxylic acid. However, within this context, it is particularly advantageously if a stabilizer composition according to the invention comprises a mixture of at least one zinc salt of an organic carboxylic acid having 16 carbon atoms or more and at least one zinc salt of an organic carboxylic acid having less than 16 carbon atoms.

Suitable organic carboxylic acids are for example caproic acid, caprylic acid, capric acid, lauric acid, myristic acid, oenanthic acid, octanoic acid, neodecanoic acid, 2-ethylhexanoic acid, pelargonic acid, decanoic acid, undecanoic acid, dodecanoic acid, tridecanoic acid, palmitic acid, lauric acid, linoleic acid, linolenic acid, erucic acid, isostearic acid, stearic acid, 12-hydroxystearic acid, 9,10-dihydroxystearic acid, oleic acid, 3,6-dioxaheptanoic acid, 3,6,9-trioxadecanoic acid or behenic acid.

It is advantageous that the ratio of a zinc salt or a mixture of two or more zinc salts of carboxylic acids having 16 carbon atoms or more to a zinc salt or a mixture of two or more zinc salts of carboxylic acids having less than 16 carbon atoms is about 1:100 to about 100:1, in particular about 1:10 to about 10:1.

Within the scope of a preferred embodiment of the present invention, a stabilizer composition according to the invention comprises a mixture of zinc stearate and at least one further organic zinc salt, whereas the at least further organic zinc salt is preferably a zinc salt of an organic carboxylic acid having less than 16 carbon atoms. Thereby, special preference is given to a mixture of zinc stearate and zinc caprylate.

The proportion of a mixture of two or more of the above mentioned zinc salts in the stabilizer composition according to the invention is preferably about 0.1 to about 5 phr, based on the amount of the halogen-containing polymer to be stabilized, for example about 0.2 to about 2 phr or about 0.8 to about 1.2 phr.

Furthermore, for the processing and stabilizing properties of the present stabilizer composition according to the invention it has advantageously turned out if the stabilizer composition comprises a triglyceride. Within this context, suitable triglycerides are all triglycerides, which at least does not detrimentally affect the processing properties of a polymer composition, which comprises a stabilizer composition according to the invention.

Suitable triglycerides are for example natural or synthetic fats. It has turned according to the invention that the application of triglycerides together with the above mentioned compounds in a stabilizer composition according to the invention, achieves an enhancement of the surface structure during the extrusion. Further advantageous effects are a good hydrolysis resistance, a fast gelling, setting ability for great amounts of fillers, no plate out effect.

Thereby, glycerine stearates such as purified suet, hardened suet, purified or rather hardened fish oil or glycerine(tri-12-hydroxystearates) such as hardened caster oil or mixtures of two or more of the mentioned compounds are particularly suitable. Especially suitable is hardened suet or rather hardened caster oil.

The stabilizer composition according to the invention can additionally comprise at least one further additive or a mixture of two or more of the mentioned additives. The subsequently mentioned additives can be comprised according to the invention in a total amount of about 2 to 99.9% by weight, based on the total stabilizer composition. A stabilizer composition according to the invention preferably comprises overall about 0.1 to about 2 phr of constituent (a), (b) and (c).

For example, further amino alcohols are suitable additives. Within the scope of the present invention, generally all compounds are suitable as amino alcohols, which have at least one OH group and one primary, secondary or tertiary amino group or a combination of two or more of the mentioned amino groups. In general, within the scope of the present invention, both solid and liquid amino alcohols are suitable as constituent of the stabilizer composition according to the invention. However, within the scope of the present invention, for example the proportion of liquid amino alcohols is selected that way that the total stabilizer composition is present in a substantially solid form.

Within the scope of a preferred embodiment of the present invention, amino alcohols, that are applicable within the scope of the present invention, have a melting point of more than about 30° C., in particular of more than about 50° C. Suitable amino alcohols are for example mono- or polyhydroxy compounds, which built up on linear or branched, saturated or unsaturated aliphatic mono- or polyamines.

For example, OH-group-containing derivatives of primary mono- or polyamino compounds, having from 2 to about 40, for example from 6 to about 20 carbon atoms, are suitable for this. For example, these are corresponding OH-group-containing derivatives of ethylamine, n-propylamine, i-propylamine, sec.-propylamine, tert.-butylamine, 1-aminoisobutane, substituted amines having from two to about 20 carbon atoms such as 2-(N,N-dimethylamino)-1-aminoethane. Suitable OH-group-containing derivatives of diamines are for example those, which derive from diamines having a molecular weight of about 32 to about 200 g/mol, whereas the corresponding diamines have at least two primary, two secondary or one primary and one secondary amino group. Examples for this are diaminoethane, the isomeric diaminopropanes, the isomeric diaminobutanes, the isomeric diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines, such as diethylenetriamine or 1,8-diamino-4-aminomethyloctane, triethylamine, tributylamine, dimethylbenzylamine, N-ethyl-, N-methyl-, N-cyclohexyl-morpholine, dimethylcyclohexylamine, dimorpholinodiethyl ether, 1,4-diazabicyclo[2,2,2]octane, 1-azabicyclo[3,3,0]octane, N,N,N′,N′-tetramethylethylenediamine, N,N,N′,N′-tetramethylbutanediamine, N,N,N′,N′-tetramethyl-1,6-hexanediamine, pentamethyldiethylenetriamine, tetramethyldiaminoethyl ether, bis(dimethylaminopropyl)urea, N,N′-dimethylpiperazine, 1,2-dimethylimidazole or di(4-N,N-dimethyl-aminocyclohexyl)methane.

Especially suitable are aliphatic amino alcohols having from 2 to about 40, preferably from 6 to about 20 carbon atoms, for example 1-amino-3,3-dimethyl-pentan-5-ol, 2-aminohexane-2′,2″-diethanolamine, 1-amino-2,5-dimethylcyclo-hexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentane-methanol, 2-amino-2-ethyl-1,3-propanediol, 2-(dimethylaminoethoxy)-ethanol, aromatic-aliphatic or aromatic-cycloaliphatic amino alcohols having from 6 to about 20 carbon atoms, there coming into consideration as aromatic structures heterocyclic or isocyclic ring systems such as naphthalene or especially benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol as well as mixtures of two or more of such compounds.

Also suitable as additives within the scope of the present invention are compounds having a structural element of the general formula III

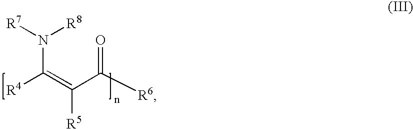

wherein n is a number from 1 to 100,000, the radicals R⁷, R⁸, R⁴ and R⁵ are each independently of the others hydrogen, an unsubstituted or substituted linear or branched, saturated or unsaturated aliphatic alkyl radical having from 1 to 44 carbon atoms, an unsubstituted or substituted saturated or unsaturated cycloalkyl radical having from 6 to 44 carbon atoms or an unsubstituted or substituted aryl radical having from 6 to 44 carbon atoms or an unsubstituted or substituted aralkyl radical having from 7 to 44 carbon atoms or the radical R⁴ is an unsubstituted or substituted acyl radical having from 2 to 44 carbon atoms or the radicals R⁴ and R⁵ are linked to form an aromatic or heterocyclic system and wherein the radical R⁶ is hydrogen, an unsubstituted or substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having from 1 to 44 carbon atoms, an unsubstituted or substituted saturated or unsaturated cycloalkyl or cycloalkylene radical or oxycycloalkyl or oxycycloalkylene radical or mercaptocycloalkyl or mercaptocycloalkylene radical or aminocycloalkyl or aminocycloalkylene radical having from 6 to 44 carbon atoms or an unsubstituted or substituted aryl or arylene radical having from 6 to 44 carbon atoms or an ether or thioether radical having from 1 to 20 O or S atoms or O and S atoms or is a polymer that is bonded to the structural element in brackets by way of O, S, NH, NR⁴ or CH₂C(O) or the radical R⁶ is so linked to the radical R⁴ that in total an unsubstituted or substituted, saturated or unsaturated heterocyclic ring system having from 4 to 24 carbon atoms is formed, or comprise a mixture of two or more compounds of the general formula I.

Within the scope of a preferred embodiment of the present invention, as the compound of the general formula III there is used a compound based on an α,β-unsaturated β-aminocarboxylic acid, especially a compound based on β-aminocrotonic acid. Especially suitable are the esters or thioesters of corresponding aminocarboxylic acids with monovalent or polyvalent alcohols or mercaptans wherein X in each of the mentioned cases is O or S.

When the radical R⁶ together with X is an alcohol or mercaptan radical, such a radical can be formed, for example, from methanol, ethanol, propanol, isopropanol, butanol, 2-ethylhexanol, isooctanol, isononanol, decanol, lauryl alcohol, myristyl alcohol, palmityl alcohol, stearyl alcohol, ethylene glycol, propylene glycol, 1,3-butanediol, 1,4-butanediol, 1,6-hexanediol, 1,10-decanediol, diethylene glycol, thio-diethanol, trimethylolpropane, glycerol, tris(2-hydroxymethyl)isocyanurate, triethanolamine, pentaerythiritol, di-trimethylolpropane, diglycerol, sorbitol, mannitol, xylitol, di-pentaerythritol and also the corresponding mercapto derivatives of the mentioned alcohols.

A detailed description of the compounds of the general formula III, that are applicable within the scope of the present invention, is in WO 02/068526 on the pages 7 to 10, whereas reference is expressly made to this document as well as the corresponding disclosure and the disclosure is regarded as being part of disclosure of the present text.

Also suitable as additive are compounds having at least one mercapto-functional, sp²-hybridised carbon atom, such as they are described in WO 02/068526 on the pages 10 to 11. To this document as well as the corresponding disclosure, reference is expressly made and the disclosure is regarded as being a part of the disclosure of the present text.

Furthermore, a stabilizer composition according to the invention can comprise fillers, such as those described on pages 393 to 449 of “Handbook of PVC Formulating”, E. J. Wickson, John Wiley & Sons, Inc., 1993, or reinforcing agents, such as those described on pages 549 to 615 of “Taschenbuch der Kunststoffadditive”, R. Gächter/H. Müller, Carl Hanser Verlag, 1990, or pigments.

Salts of halogen-containing oxy acids, especially perchlorate, are also suitable additives. Examples of suitable perchlorates are those of the general formula M(ClO₄)ₙ, wherein M is Li, Na, K, Mg, Ca, Sr, Zn, Al, La or Ce. The index n, according to the valency of M, is the number 1, 2 or 3. The mentioned perchlorate salts can be complexed with alcohols (polyols, cyclodextrins) or ether alcohols or ester alcohols. Ester alcohols include the polyol partial esters. Suitable polyvalent alcohols or polyols also include their dimers, trimers, oligomers and polymers, such as di-, tri-, tetra- and poly-glycols as well as di-, tri- and tetra-pentaerythritol or polyvinyl alcohol in various degrees of polymerisation and hydrolysis. As polyol partial esters preference is given to glycerol monoethers and glycerol monothioethers. Also suitable are sugar alcohols and thio sugars.

The perchlorate salts can be used in various common delivery forms, for example in the form of a salt or an aqueous solution supported on a suitable carrier material, such as PVC, calcium silicate, zeolites, calcium hydroxide, calcium oxide or hydrotalcites, or bonded by chemical reaction into a hydrotalcite. In view of perchlorate compounds being supported on calcium oxide or calcium hydroxide, reference is expressly made to DE 101 24 734 A1, whereas the disclosure of this document that concerns supported perchlorates is regarded as being a part of the disclosure of the present text.

Also suitable as additive are, for example, basic calcium-aluminium hydroxy-phosphites of the general formula (IV)
CaₓAl₂(OH)_{2(x+3-y)}(HPO₃)_{y}m H₂O (IV)

whereas 2≦x≦12, (2x+5)2>y>0 and 0≦m≦12. Compounds of the general formula (IV) are described for example in DE 41 06 411 A. Further basic calcium-aluminium hydroxyphosphites are described in DE-A-3941902. Reference is expressly made to the disclosure of the mentioned documents concerning basic calcium-aluminium hydroxyphosphites. The disclosure is regarded as part of the disclosure of the present text.

Also suitable as additives in the context of the stabilizer compositions according to the invention are basic calcium-aluminium hydroxycarboxylates of the general formula (V)
CaₓAl₂(OH)_{[(2x+6)-y]}A_{y/n}ⁿ⁻*m H₂O (V),

whereas 2≦x≦12, (2x+5)2>y>0, 0≦m≦12 and 1≦n≦8, and Aⁿ⁻ is an aliphatic saturated, unsaturated, linear or branched single- or multifunctional carboxylic acid anion having from 1 to 22 carbon atoms or an aromatic or heteroaromatic single- or multifunctional carboxylic acid anion having from 6 to 20 carbon atoms.

The carboxylic acid anion Aⁿ⁻ in the general formula (V) can, for example, be selected from anions of malonic, succinic, adipinic, fumaric, maleic, phthalic, isophthalic, terephthalic, pyridinic, benzoic, salicylic, tartronic, malic, tartaric, acetone dicarbonic, oxaloacetic, aconitic and citric acid. Preference is given to anions of fumaric and phthalic acid, in particular fumarates are applied.

Compounds of the general formula (V) are, for example, known from DE 41 06 404 A.

Further calcium-aluminium hydroxycarboxylates are described in DE 40 02 988 A, whereas reference is expressly made to the disclosure of these documents concerning the mentioned calcium-aluminium hydroxycarboxylates and this disclosure is a part of the disclosure of the present text.

Polyols are also suitable as additives in the context of the stabilizer composition according to the invention. Suitable polyols are, for example, pentaerythritol, dipentaerythritol, tripentaerythritol, bistrimethylolpropane, inositol, polyvinyl alcohol, bistrimethylolethane, trimethylolpropane, sorbitol, maltitol, isomaltitol, lactitol, lycasine, mannitol, lactose, leucrose, tris(hydroxymethyl) isocyanurate, palatinite, tetramethylolcyclohexanol, tetramethylolcyclopentanol, tetramethylol-cycloheptanol, glycerol, diglycerol, polyglycerol, thiodiglycerol or 1-0-α-D-glycopyranosyl-D-mannitol dihydrate.

Also suitable as additives are, for example, epoxy compounds. Examples of such epoxy compounds are epoxidised soybean oil, epoxidised olive oil, epoxidised linseed oil, epoxidised castor oil, epoxidised groundnut oil, epoxidised maize oil, epoxidised cottonseed oil, and also glycidyl compounds. Suitable as glycidyl compounds are in particular the glycidyl compounds such as they are described in WO 02/068526 on the pages 20 to 22. Reference is expressly made to the disclosure of the mentioned document concerning the glycidyl compounds and it is regarded as being part of the disclosure of the present text.

Especially suitable epoxy compounds are described, for example, on pages 3 to 5 of EP-A 1 046 668, reference being expressly made to the disclosure contained therein, which is to be regarded as part of the disclosure of the present text.

Also suitable as additive are, for example zeolites, which can be described by the general formula Mₓⁿ[(AlO₂)ₙₓ(SiO₂)_{y}]*m H₂O, wherein n is the valency of the cation M (e.g. alkaline or earth alkali metal), 0.8≦x, y≦15 and 0≦m≦300.

Also suitable as additives are, for example, sterically hindered amines, such as those mentioned on pages 7 to 27 of EP-A 1 046 668. Reference is expressly made to the sterically hindered amines disclosed therein, the compounds mentioned therein being regarded as part of the disclosure of the present text.

Also suitable as additive are uracils and aminouracils such as they are mentioned for example in EP 1 046 668. The disclosure of the mentioned document that concerns aminouracils is regarded as part of the disclosure of the present text.

Furthermore, amino acids and their alkali and earth alkali salts are suitable as additives.

Also suitable as additives are hydrocalumites of the general formula Al—Caₓ(OH)₂ₓ₊₃*m H₂O; x=1 to 4; m=0 to 8, which are for example described in DE 41 03 881. Reference is expressly made to the mentioned document and whose disclosure concerning the mentioned hydrocalumites and the disclosure is regarded as being part of the disclosure of the present invention.

Furthermore, a stabilizer composition according to the invention can further on comprise an organotin compound or a mixture of two or more organotin compounds as additive. Suitable organotin compounds are, for example, methyltin-tris(isooctyl-thioglycolate), methyltin-tris(isooctyl-3-mercaptopropionate), methyltin-tris(isodecyl-thioglycolate), dimethyltin-bis(isooctyl-thioglycolate), dibutyltin-bis(isooctyl-thioglycollate), monobutyltin-tris(isooctyl-thioglycolate), dioctyltin-bis(isooctyl-thioglycolate), monooctyltin-tris(isooctyl-thioglycolate) or dimethyltin-bis(2-ethylhexyl-β-mercaptopropionate).

Furthermore, in the context of the stabilizer compositions according to the invention it is possible to use the organotin compounds which are mentioned and the preparation of which is described on pages 18 to 29 of EP-A 0 742 259. Reference is expressly made to the above-mentioned disclosure, the compounds mentioned therein and their preparation being understood as being part of the disclosure of the present text. Also suitable as additives are latent mercaptans such as they are described in EP 0 742 259 A1 and EP 1 201 706 A1 as well as cyanoacetylureas according to DE 299 24 285 U1, whereas reference is expressly made to the above mentioned passages of disclosure and the compound and their preparation mentioned therein are understood as being part of the disclosure of the present text.

Within the scope of a further embodiment of the present invention, a stabilizer composition according to the invention can comprise organic phosphite esters having from 1 to 3 identical, pairwise identical or different organic radicals. Suitable organic radicals are, for example, linear or branched, saturated or unsaturated alkyl radicals having from 1 to 24 carbon atoms, unsubstituted or substituted alkyl radicals having 6 to 20 carbon atoms or unsubstituted or substituted aralkyl radicals having from 7 to 20 carbon atoms. Examples of suitable organic phosphite esters are tris(nonylphenyl), trilauryl, tributyl, trioctyl, tridecyl, tridodecyl, triphenyl, octyldiphenyl, dioctylphenyl, tri(octylphenyl), tribenzyl, butyldicresyl, octyl-di(octylphenyl), tris(2-ethylhexyl), tritolyl, tris(2-cyclohexylphenyl), tri-α-naphthyl, tris(phenylphenyl), tris(2-phenylethyl), tris(dimethylphenyl), tricresyl or tris(p-nonylphenyl)phosphite or tristearyl sorbitol-triphosphite or mixtures of two or more thereof.

A stabilizer composition according to the invention can also comprise lubricants, such as montan waxes, fatty acid esters, purified or hydrogenated natural or synthetic triglycerides or partial esters, polyethylene waxes, amide waxes, chloroparaffins, glycerol esters or earth alkali soaps. Lubricants suitable for use are also described in “Kunststoffadditive”, R. Gächter/H. Müller, Carl Hanser Verlag, 3rd edition, 1989, pages 478-488. Also suitable as lubricants are, for example, fatty ketones, as described in DE 4,204,887, and also silicone-based lubricants, as mentioned, for example, in EP-A 0 259 783, or combinations thereof, as mentioned in EP-A 0 259 783. Reference is herewith expressly made to the mentioned documents, whose disclosure relating to lubricants is regarded as being part of the disclosure of the present text.

Also suitable as additives for stabilizer compositions according to the present invention are organic plasticisers.

Suitable as plasticisers are, for example, compounds, that are mentioned above within the context of the description of solvents, from the group of phthalic acid esters, such as dimethyl, diethyl, dibutyl, dihexyl, di-2-ethylhexyl, di-n-octyl, diiso-octyl, diisononyl, diisode-cyl, dicyclohexyl, dimethylcyclohexyl, dimethyl glycol, dibutyl glycol, benzylbutyl or diphenyl phthalate and also mixtures of phthalates, for example mixtures of alkyl phthalates having from 7 to 9 or 9 to 11 carbon atoms in the ester alcohol or mixtures of alkyl phthalates having from 6 to 10 and 8 to 10 carbon atoms in the ester alcohol. Especially suitable in the sense of the present invention are thereby dibutyl, dihexyl, di-2-ethylhexyl, di-n-octyl, diisooctyl, diisononyl, diisodecyl, diisotridecyl and benzylbutyl phthalate and also the mentioned mixtures of alkyl phthalates.

Also suitable as plasticisers are the esters of aliphatic dicarboxylic acids, especially the esters of adipic, azelaic or sebacic acid or mixtures of two or more thereof. Examples of such plasticisers are di-2-ethylhexyl adipate, diisooctyl adipate, diisononyl adipate, diisodecyl adipate, benzylbu-tyl adipate, benzyloctyl adipate, di-2-ethylhexyl azelate, di-2-ethylhexyl sebacate and diisodecyl sebacate. Within the scope of a further embodiment of the present invention preference is given to di-2-ethylhexyl acetate and diisooctyl adipate.

Also suitable as plasticisers are trimellitic acid esters, such as tri-2-ethylhexyl trimellitate, triisotridecyl trimellitate, triisooctyl trimellitate and also trimellitic acid esters having from 6 to 8, 6 to 10, 7 to 9 or 9 to 11 carbon atoms in the ester group or mixtures of two or more of the mentioned compounds.

Suitable plasticisers are also, for example, polymer plasticisers, as mentioned in “Kunststoffadditive”, R. Gächter/H. Müller, Carl Hanser Verlag, 3rd edition, 1989, chapter 5.9.6, pages 412-415, or “PVC Technology”, W. V. Titow, 4th Edition, Elsevier Publishers, 1984, pages 165-170. The starting materials most commonly used for the preparation of polyester plasticisers are, for example, dicarboxylic acids, such as adipic, phthalic, azelaic or sebacic acid, and diols, such as 1,2-propanediol, 1,3-butanediol, 1,4-butanediol, 1,6-hexanediol, neopentyl glycol or diethylene glycol or mixtures of two or more thereof.

Also suitable as plasticisers are phosphoric acid esters, such as those in “Taschenbuch der Kunststoffadditive”, chapter 5.9.5, pages 408-412. Examples of suitable phosphoric acid esters are tributyl phosphate, tri-2-ethylbutyl phosphate, tri-2-ethylhexyl phosphate, trichloroethyl phosphate, 2-ethyl-hexyl-di-phenyl phosphate, triphenyl phosphate, tricresyl phosphate or trixylenyl phosphate, or mixtures of two or more thereof.

Also suitable as plasticisers are chlorinated hydrocarbons (paraffins) or hydrocarbons as described in “Kunststoffadditive”, R. Gächter/H. Müller, Carl Hanser Verlag, 3rd edition, 1989, chapter 5.9.14.2, pages 422-425, and chapter 5.9.14.1, page 422.

Within the scope of a further embodiment of the present invention, the stabilizer compositions according to the invention can comprise antioxidants, UV absorbers and light stabilizers or blowing agents. Suitable antioxidants are described, for example, on pages 33 to 35 of EP-A 1 046 668. Therein, suitable UV absorbers and light stabilizers are mentioned on pages 35 and 36. Reference is expressly made to both disclosures, whereas the disclosures are regarded as part of the present text.

Suitable blowing agents are, for example, organic azo and hydrazo compounds, tetrazoles, oxazines, isatoic anhydride, salts of citric acid, for example ammonium citrate, and also sodium carbonate and sodium hydrogen carbonate. Especially suitable are, for example, ammonium citrate, azodicarbonamide or sodium hydrogen carbonate or mixtures of two or more thereof.

A stabilizer composition according to the invention can also comprise impact strength modifiers and processing aids, gelling agents, antistatics, biocides, metal deactivators, optical brighteners, flame retardants and also antifogging compounds. Suitable compounds of those compound classes are described, for example, in “Kunststoff Additive”, R. Keβler/H. Müller, Carl Hanser Verlag, 3rd edition, 1989 as well as in “Handbook of PVC Formulating”, E. J. Wilson, J. Wiley & Sons, 1993.

In general, a stabilizer composition according to the invention can be prepared by any way by mixing the respective constituents.

Therefore, the object of the present invention is also a process for the preparation of a stabilizer composition for stabilizing halogen-containing thermoplastic resins, in which

(a) calcium hydroxide or calcium oxide or a mixture thereof,

(b) at least one hydroxyl-group-containing isocyanurate and

(c) at least one β-diketone or a salt of a β-diketone or a mixture thereof,

are mixed together, whereas the weight content of the constituent (c) is measured that way that it is less than 0.5 phr, based on the thermoplastic resin to be stabilized or the thermoplastic resins to be stabilized.

As the weight content of the different constituents in a stabilizer composition according to the invention can be based on the total weight of the stabilizer composition itself within the scope of a further embodiment of the invention, the present invention also relates to a process for the preparation of a stabilizer composition for stabilizing halogen-containing thermoplastic resins, in which

(a) calcium hydroxide or calcium oxide or a mixture thereof,

(b) at least one hydroxyl-group-containing isocyanurate and

(c) at least one β-diketone or a salt of a β-diketone or a mixture thereof,

are mixed together, whereas the weight content of the constituent (c) is less than 2.369% by weight, based on the total weight of the stabilizer composition.

The stabilizer compositions according to the invention is suitable for stabilizing halogen-containing polymers.

Examples of such halogen-containing polymers are polymers of vinyl chloride, vinyl resins containing vinyl chloride units in the polymer backbone, copolymers of vinyl chloride and vinyl esters of aliphatic acids, especially vinyl acetate, copolymers of vinyl chloride with esters of acrylic and methacrylic acid or acrylonitrile or mixtures of two or more thereof, copolymers of vinyl chloride with diene compounds or unsaturated dicarboxylic acids or anhydrides thereof, for example copolymers of vinyl chloride with diethyl maleate, diethyl fumarate or maleic anhydride, post-chlorinated polymers and copolymers of vinyl chloride, copolymers of vinyl chloride and vinylidene chloride with unsaturated aldehydes, ketones and other compounds such as acrolein, crotonaldehyde, vinyl methyl ketone, vinyl methyl ether, vinyl isobutyl ether and the like, polymers and copolymers of vinylidene chloride with vinyl chloride and other polymerisable compounds, such as those already mentioned above, polymers of vinyl chloroacetate and dichlorodivinyl ether, chlorinated polymers of vinyl acetate, chlorinated polymeric esters of acrylic acid and α-substituted acrylic acids, chlorinated polystyrenes, for example polydichlorostyrene, chlorinated polymers of ethylene, polymers and post-chlorinated polymers of chlorobutadiene and copolymers thereof with vinyl chloride and also mixtures of two or more of the mentioned polymers or polymer mixtures that contain one or more of the above-mentioned polymers. Within the scope of a preferred embodiment of the present invention, the stabilizer compositions according to the invention are used for the production of moulded articles of PVC-U, such as window profiles, industrial profiles, tubes and plates.

Also suitable for the stabilization with the stabilizer compositions according to the invention are the graft polymers of PVC with EVA, ABS or MBS. Preferred substrates for such graft copolymers are also the afore-mentioned homo- and copolymers, especially mixtures of vinyl chloride homo-polymers with other thermoplastic or elastomeric polymers, especially blends with ABS, MBS, NBR, SAN, EVA, CPE; MBAS, PAA (polyalkyl acrylate), PAMA (polyalkyl methacrylate), EPDM, polyamides or polylactones.

Likewise suitable for the stabilization with the stabilizer compositions according to the invention are mixtures of halogenated and non-halogenated polymers, for example mixtures of the above-mentioned non-halogenated polymers with PVC, especially mixtures of polyurethanes and PVC.

Furthermore, it is also possible for recyclates of chlorine-containing polymers to be stabilized with the stabilizer compositions according to the invention, in principle any recyclates of the above-mentioned halogenated polymers being suitable for this purpose. PVC recyclate, for example, is suitable in the context of the present invention.

The stabilizer composition according to the invention is preferably used for polyvinylchloride (PVC) as halogen-containing thermoplastic resin. For example, it is used for PVC-U (hard PVC)

Thereby, the term polyvinylchloride, which is used herein, comprises the common homo- and co-polymers of vinyl chloride as well as blends of such polyvinyl chloride compounds with other polymer compounds. Such polymers can have been prepared by any way, for example by suspension, emulsion or block polymerization. Their K value can be for example between 50 and 100.

It has turned out that in particular moulded articles of PVC-U for the application outside, which have an unanticipated high weathering and thermal stability as well as excellent processing properties, can be produced by using a stabilizer composition according to the invention.

A further object of the present invention is therefore related to a polymer composition, at least comprising a halogenated polymer and a stabilizer composition according to the invention. The details given in terms of the stabilizer composition are therefore effective for a polymer composition according to the present invention in view of the stabilizer constituents that are comprised in such a polymer composition. The polymer composition according to the present invention finally differs from the stabilizer composition according to the invention in that the stabilizer composition comprises no polymer. In other respects, the properties of the stabilizer composition comprised in the polymer composition and the properties of the stabilizer composition according to the invention are identically, in such a way the above mentioned details concerning the stabilizer compositions are also effective for the stabilizer constituents comprised in the polymer compositions.

Within the scope of a preferred embodiment of the present invention, a polymer composition according to the invention comprises the stabilizer composition according to the invention in an amount of about 0.1 to 20 phr, in particular about 0.5 to about 15 phr or about 1 to about 12 phr or about 1.5 to 5 phr. Thereby, the optimal amount for the individual case also depends from the used lubricants. The unit phr represents “per hundred resin” and thus relates to parts by weight per 100 parts by weight of polymer. Suitable charging amounts are, for example, in a range of about 2-3 phr or rather 3-4 phr, if a proportion of processing aids is added.

The polymer composition according to the invention preferably comprises at least in part PVC as halogenated polymer, whereas the proportion of PVC is in particular at least about 20, preferably at least about 50% by weight, for example at least about 80 or at least about 90% by weight.

The mixing together of polymer or polymers and the stabilizer composition according to the invention for the preparation of the polymer composition according to the invention can in principle be effected at any time before or during the processing of the polymer. For example, the stabilizer composition can be mixed prior to processing into the polymer, which is in powder or granule form. It is equally possible, however, to add the stabilizer composition to the polymer or polymers in the softened or molten state, for example during processing in an extruder.

Therefore, the object of the present invention is also a process for the preparation of a polymer composition, comprising a stabilizer composition and at least one polymer, in which at least
(a) calcium hydroxide or calcium oxide or a mixture thereof,
(b) at least one hydroxyl-group-containing isocyanurate,
(c) at least one β-diketone or a salt of a β-diketone or a mixture thereof and
(d) a halogen-containing thermoplastic resin or a mixture of two or more halogen-containing thermoplastic resins

are mixed, whereas the weight content of the constituent (c) is less than 0.5 phr, based on the thermoplastic resin to be stabilized or the thermoplastic resins to be stabilized.

The stabilizer composition according to the invention can be present in any physical form, e.g. as powder mixture, press, spray or micro granules, flakes or pastilles. These product forms can either be brought in form of granules by pressure and/or temperature an/or by addition of granulating aids from powder mixtures or can be formed in flakes, pastilles or prills by cooling or rather spraying melts of the composition according to the invention. For the preparation of halogen-containing resin compounds, before or during the processing the individual substances can be added directly or as mixture in the above mentioned product form. Then, the halogen-containing thermoplastic resin compounds can be formed to moulded articles in a known manner.

A polymer composition according to the invention can be brought into a desired form in a known manner. Suitable methods are, for example, calendering, extrusion, injection-moulding, sintering, extrusion blowing or the plastisol process. A polymer composition according to the invention can also be used, for example, in the production of foamed materials. In principle, the polymer compositions according to the invention are suitable for the production of hard or soft PVC.

A polymer composition according to the invention can be processed to form moulded articles. The present invention therefore relates also to moulded articles, at least comprising a stabilizer composition according to the invention or a polymer composition according to the invention.

The term “moulded article” includes in the context of the present invention in principle any three-dimensional structures that can be produced from a polymer composition according to the invention. In the context of the present invention the term “moulded article” includes, for example, wire sheathings, automobile components, for example automobile components such as they are used in the interior of the automobile, in the engine space or on the outer surfaces, cable insulators, decorative films, agricultural films, hoses, shaped sealing elements, office films, hollow bodies (bottles), packaging films, (deep-draw films), blown films, tubes, foamed materials, heavy duty profiles (window frames), light wall profiles, structural profiles, sidings, fittings, plates, foamed panels, co-extrudates having a recycled core, or housings for electrical apparatus or machinery, for example computers or household appliances. Further examples of moulded articles that can be produced from a polymer composition according to the invention are synthetic leather, floor coverings, textile coatings, wallcoverings, coil coatings and under-seals for motor vehicles.

Object of the present invention is also the use of a stabilizer composition according to the invention or a stabilizer composition produced according to the invention or a polymer composition according to the invention for the production of polymeric moulded articles or means for surface coating.

Object of the invention particularly is the use of a stabilizer composition for stabilizing a halogen-containing thermoplastic resin or a mixture of two or more halogen-containing thermoplastic resins, whereas the stabilizer composition comprises at least

(a) calcium hydroxide or calcium oxide or a mixture thereof,

(b) at least one hydroxyl-group-containing isocyanurate and

(c) at least one β-diketone or a salt of a β-diketone or a mixture thereof and

whereas the weight content of the constituent (c) is less than 0.5 phr, based on the thermoplastic resin to be stabilized or the thermoplastic resins to be stabilized.

As the weight content of the different constituents in the stabilizer composition according to the invention can also be based on the total weight of the stabilizer composition itself, the present invention also relates to the use of a stabilizer composition for stabilizing a halogen-containing thermoplastic resin or a mixture of two or more halogen-containing thermoplastic resins, whereas the stabilizer composition comprises at least

(a) calcium hydroxide or calcium oxide or a mixture thereof,

(b) at least one hydroxyl-group-containing isocyanurate and

(c) at least one β-diketone or a salt of a β-diketone or a mixture thereof and

whereas the weight content of the constituent (c) is less than 2,369% by weight, based on the total weight of the stabilizer composition.

Subsequently, the invention is explained in greater detail by examples.

### EXAMPLES

The following examples, which are described in the formulation tables A and B, describe the invention. The thermostability was evaluated in the examples by determination of the DHC value according to DIN 53381, part 1 process B.

Processing

The constituents of the formulations were mixed together with PVC and other additives in a heating/cooling mixer, up to a processing temperature of 120° C., and subsequently cooled to 40° C. The dryblend prepared that way was then extruded to profiles by an extruder.

Examples A1 to A6, Variation of the β-diketone proportion

| | A1 | A2 | A3 | A4 | A5 | A6 |
|---|---|---|---|---|---|---|
| S-PVC | 100 | 100 | 100 | 100 | 100 | 100 |
| Chalk | 5 | 5 | 5 | 5 | 5 | 5 |
| Impact | 7 | 7 | 7 | 7 | 7 | 7 |
| strength | | | | | | |
| modifier | | | | | | |
| TiO₂ | 4 | 4 | 4 | 4 | 4 | 4 |
| Flowing aid | 1 | 1 | 1 | 1 | 1 | 1 |
| 41 | | | | | | |
| Distearyl | 0.6 | 0.6 | 0.6 | 0.6 | 0.6 | 0.6 |
| phthalate | | | | | | |
| Paraffin wax | 0.2 | 0.2 | 0.2 | 0.2 | 0.2 | 0.2 |
| Benzoyl- | 0.2 | 0.2 | 0.2 | 0.15 | 0.1 | 0.09 |
| stearoyl- | | | | | | |
| methane | | | | | | |
| Caclium | 0.3 | 0.25 | 0.2 | 0.2 | 0.2 | 0.2 |
| acetyl- | | | | | | |
| acetonate | | | | | | |
| Zinc stearate | 0.5 | 0.5 | 0.5 | 0.5 | 0.5 | 0.5 |
| Zinc caprylate | 0.3 | 0.3 | 0.3 | 0.3 | 0.3 | 0.3 |
| Hydrotalcite | 0.5 | 0.5 | 0.5 | 0.5 | 0.5 | 0.5 |
| Calcium | 0.5 | 0.5 | 0.5 | 0.5 | 0.5 | 0.5 |
| hydroxide | | | | | | |
| THEIC | 0.3 | 0.3 | 0.3 | 0.3 | 0.3 | 0.3 |
| DHC value | 66 | 61 | 52 | 50 | 48 | 48 |
| Surface | — | ◯ | ◯ | ◯ | ◯ | ◯ |
| Initial gel | — | ◯ | ◯ | ◯ | + | + |
| formation | | | | | | |

Example A1 complies with example A4 of PCT/EP99/02548

The evaluation of the profile surface and of the initial gel formation was performed by means of a scale of the appraisal facilities −−, −, O, + and ++, whereas −− is an unacceptable, − a bad, O an average, + an above-average and ++ an excellent appraisal.

Examples A7 to A12, Variation of the β-diketone proportion

| | A7 | A8 | A9 | A10 | A11 | A12 |
|---|---|---|---|---|---|---|
| S-PVC | 100 | 100 | 100 | 100 | 100 | 100 |
| Chalk | 5 | 5 | 5 | 5 | 5 | 5 |
| Impact | 7 | 7 | 7 | 7 | 7 | 7 |
| strength | | | | | | |
| modifier | | | | | | |
| TiO₂ | 4 | 4 | 4 | 4 | 4 | 4 |
| Flowing aid | 1 | 1 | 1 | 1 | 1 | 1 |
| 41 | | | | | | |
| Distearyl | 0.6 | 0.6 | 0.6 | 0.6 | 0.6 | 0.6 |
| phthalate | | | | | | |
| Paraffin wax | 0.2 | 0.2 | 0.2 | 0.2 | 0.2 | 0.2 |
| Benzoyl- | 0.1 | 0.1 | 0.09 | 0.05 | 0.025 | 0.01 |
| stearoyl- | | | | | | |
| methane | | | | | | |
| Caclium | 0.15 | 0.1 | 0.05 | 0.05 | 0.025 | 0.01 |
| acetyl- | | | | | | |
| acetonate | | | | | | |
| Zinc stearate | 0.5 | 0.5 | 0.5 | 0.5 | 0.5 | 0.5 |
| Zinc caprylate | 0.3 | 0.3 | 0.3 | 0.3 | 0.3 | 0.3 |
| Hydrotalcite | 0.5 | 0.5 | 0.5 | 0.5 | 0.5 | 0.5 |
| Calcium | 0.5 | 0.5 | 0.5 | 0.5 | 0.5 | 0.5 |
| hydroxide | | | | | | |
| THEIC | 0.3 | 0.3 | 0.3 | 0.3 | 0.3 | 0.3 |
| DHC value | 46 | 44 | 43 | 37 | 30 | 17 |
| Surface | + | + | ++ | ++ | + | + |
| Initial gel | + | ++ | + | ++ | ++ | + |
| formation | | | | | | |

Examples A13 to A 18, Variation of the calcium hydroxide and THEIC proportion

| | A13 | A14 | A15 | A16 | A17 | A18 |
|---|---|---|---|---|---|---|
| S-PVC | 100 | 100 | 100 | 100 | 100 | 100 |
| Chalk | 5 | 5 | 5 | 5 | 5 | 5 |
| Impact | 7 | 7 | 7 | 7 | 7 | 7 |
| strength | | | | | | |
| modifier | | | | | | |
| TiO₂ | 4 | 4 | 4 | 4 | 4 | 4 |
| Flowing aid | 1 | 1 | 1 | 1 | 1 | 1 |
| 41 | | | | | | |
| Distearyl | 0.6 | 0.6 | 0.6 | 0.6 | 0.6 | 0.6 |
| phthalate | | | | | | |
| Paraffin wax | 0.2 | 0.2 | 0.2 | 0.2 | 0.2 | 0.2 |
| Benzoyl- | 0.1 | 0.1 | 0.1 | 0.1 | 0.1 | 0.1 |
| stearoyl- | | | | | | |
| methane | | | | | | |
| Caclium | 0.15 | 0.15 | 0.15 | 0.15 | 0.15 | 0.15 |
| acetyl- | | | | | | |
| acetonate | | | | | | |
| Zinc stearate | 0.5 | 0.5 | 0.5 | 0.5 | 0.5 | 0.5 |
| Zinc caprylate | 0.3 | 0.3 | 0.3 | 0.3 | 0.3 | 0.3 |
| Hydrotalcite | 0.5 | 0.5 | 0.5 | 0.5 | 0.5 | 0.5 |
| Calcium | 0.1 | 0.3 | 0.3 | 0.3 | 0.2 | 0.2 |
| hydroxide | | | | | | |
| THEIC | 0.1 | 0.1 | 0.2 | 0.3 | 0.3 | 0.2 |
| DHC value | 20 | 38 | 41 | 44 | 42 | 41 |

1. A stabilizer composition for stabilizing a halogen-containing thermoplastic resin or a mixture of two or more halogen-containing thermoplastic resins, comprising
(a) calcium hydroxide, calcium oxide or a mixture thereof,
(b) at least one hydroxyl group-containing isocyanurate, and
(c) at least one β-diketone, salt of a β-diketone or a mixture thereof,
wherein constituent (b) is present in an amount of 0.01 to 30% by weight, based on the total weight of the stabilizer composition and the weight content of constituent (c) is less than 0.3 phr, based on the thermoplastic resin to be stabilized or the thermoplastic resins to be stabilized.

2. The stabilizer composition according to claim 1, wherein the weight content of constituent (a) is 0.01 to 2 phr, based on the thermoplastic resin to be stabilized or the thermoplastic resins to be stabilized.

3. The stabilizer composition according to claim 1, wherein the weight content of constituent (b) is 0.01 to 1 phr, based on the thermoplastic resin to be stabilized or the thermoplastic resins to be stabilized.

4. The stabilizer composition according to claim 1, wherein one or more of the following conditions are met:
(i) the weight content of constituent (a) is 0.05 to 0.3299 phr, based on the thermoplastic resin to be stabilized or the thermoplastic resins to be stabilized,
(ii) the weight content of constituent (b) is 0.05 to 0.299 phr, based on the thermoplastic resin to be stabilized or the thermoplastic resins to be stabilized, and
(iii) the weight content of constituent (c) is 0.01 to 0.3 phr, based on the thermoplastic resin to be stabilized or the thermoplastic resins to be stabilized.

5. The stabilizer composition according to the claim 1, further comprising calcium acetylcaetonate, zinc acetylacetonate or a mixture thereof in an amount of 0.001 to 0.3 phr, based on the thermoplastic resin to be stabilized or the thermoplastic resins to be stabilized.

6. A stabilizer composition for stabilizing a halogen-containing thermoplastic resin or a mixture of two or more halogen-containing thermoplastic resins, comprising:
(a) calcium hydroxide, calcium oxide or a mixture thereof,
(b) at least one hydroxyl-group-containing isocyanurate and
(c) at least one β-diketone, salt of a β-diketone or a mixture thereof,
wherein constituent (b) is present in an amount of 0.01 to 30% by weight, based on the total amount of the stabilizer composition and wherein constituent (c) is present in an amount of 0.01 to 1.728% by weight, based on the total weight of the stabilizer composition.

7. Stabilizer composition according to claim 6, wherein the constituent (a) is comprised in an amount of 0.01 to 30% by weight, based on the total weight of the stabilizer composition.

8. The stabilizer composition according to claim 6, wherein one or more of the following conditions are met:
(i) the weight content of constituent (a) is 0.15 to 5% by weight, based on the total weight of the stabilizer composition,
(ii) the weight content of constituent (b) is 0.1 to 5% by weight, based on the total weight of the stabilizer composition, and
(iii) the weight content of constituent (c) is 0.05 to 5% by weight, based on the total weight of the stabilizer composition.

9. The stabilizer composition according to the claim 6, further comprising calcium acetylacetonate, zinc acetylacetonate or a mixture thereof in an amount of 0.001 to 10% by weight, based on the total weight of the stabilizer composition.

10. The stabilizer composition according to claim 6, wherein the hydroxyl-group-containing isocyanurate is selected from compounds of the general formula (I) 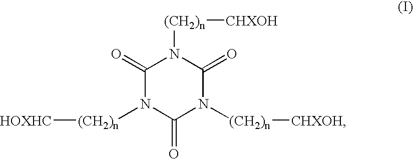
wherein the groups X and the indices n are identical or different and n is an integer of 0 to 5 and X is a hydrogen atom or a linear or branched alkyl group having 1 to 6 carbon atoms.

11. The stabilizer composition according to claim 6, further comprising a hydrotalcite or a mixture of two or more hydrotalcites.

12. The stabilizer composition according to claim 6, further comprising a mixture of zinc stearate and at least one organic zinc carboxylate.

13. The stabilizer composition according to claim 6, further comprising a triglyceride.

14. A polymer composition comprising a halogen-containing thermoplastic resin or a mixture of two or more halogen-containing thermoplastic resins and a stabilizer composition, comprising
(a) calcium hydroxide, calcium oxide or a mixture thereof,
(b) at least one hydroxyl-group-containing isocyanurate, and
(c) at least one β-diketone, salt of a β-diketone or a mixture thereof,
wherein constituent (b) is present in an amount of 0.01 to 30% by weight, based on the total weight of the stabilizer composition and wherein the weight content of constituent (c) is less than 0.3 phr, based on the thermoplastic resin to be stabilized or the thermoplastic resins to be stabilized.

15. The polymer composition according to claim 14, wherein the weight content of constituent (a) is 0.01 to 2 phr, based on the halogen-containing resin or resins.

16. The polymer composition according to claim 14, wherein constituent (b) is present in an amount of 0.01 to 1 parts by weight, based on the halogen-containing resin or resins.

17. The polymer composition according to claim 14, wherein the hydroxyl-group-containing isocyanurate is selected from compounds of the general formula (I) 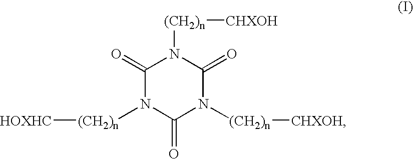
wherein the groups X and the indices n are identical or different and n is an integer of 0 to 5 and X is a hydrogen atom or a linear or branched alkyl group having 1 to 6 carbon atoms.

18. The polymer composition according to claim 14, wherein one or more of the following conditions are met:
(i) the weight content of constituent (a) is 0.05 to 0.3299 phr, based on the thermoplastic resin to be stabilized or the thermoplastic resins to be stabilized,
(ii) the weight content of constituent (b) is 0.05 to 0.299 phr, based on the thermoplastic resin to be stabilized or the thermoplastic resins to be stabilized, and
(iii) the weight content of constituent (c) is 0.01 to 0.3 phr, based on the thermoplastic resin to be stabilized or the thermoplastic resins to be stabilized.

19. The polymer composition according to claim 14, further comprising a hydrotalcite or a mixture of two or more hydrotalcites.

20. The polymer composition according to claim 14, further comprising a mixture of zinc stearate and at least one organic zinc salt.

21. The polymer composition according to claim 14, further comprising calcium acetylacetonate, zinc acetylacetonate or a mixture thereof in an amount of 0.001 to 0.3 phr, based on the thermoplastic resin to be stabilized or the thermoplastic resins to be stabilized.

22. The polymer composition according to claim 14, further comprising a triglyceride.

23. A process for the preparation of a stabilizer composition for stabilizing a halogen-containing thermoplastic resin or a mixture of two or more halogen-containing thermoplastic resins, comprising mixing
(a) calcium hydroxide, calcium oxide or a mixture thereof,
(b) at least one hydroxyl-group-containing isocyanurate and
(c) at least one β-diketone, salt of a β-diketone or a mixture thereof,
wherein constituent (b) is present in an amount of 0.01 to 30% by weight, based on the total weight of the stabilizer composition, and wherein the weight content of constituent (c) is less than 0.3 phr, based on the thermoplastic resin to be stabilized or the thermoplastic resins to be stabilized.

24. A process for the preparation of a stabilizer composition for stabilizing a halogen-containing thermoplastic resin or a mixture of two or more halogen-containing thermoplastic resins, comprising mixing
(a) calcium hydroxide, calcium oxide or a mixture thereof,
(b) at least one hydroxyl-group-containing isocyanurate and
(c) at least one β-diketone, salt of a β-diketone or a mixture thereof,
wherein constituent (b) is present in an amount of 0.01 to 30% by weight, based on the total weight of the stabilizer composition, and wherein constituent (c) is present in an amount of 0.01 to 1.728% by weight, based on the total weight of the stabilizer composition.

25. A process for the preparation of a polymer composition, comprising mixing a halogen-containing thermoplastic resin or a mixture of two or more halogen-containing thermoplastic resins and a stabilizer composition comprising,
(a) calcium hydroxide, calcium oxide or a mixture thereof,
(b) at least one hydroxyl-group-containing isocyanurate,
(c) at least one β-diketone, salt of a β-diketone or a mixture thereof,
the wherein constituent (b) is present in an amount of 0.01 to 30% by weight, based on the total weight of the stabilizer composition, and wherein the weight content of constituent (c) is less than 0.3 phr, based on the thermoplastic resin to be stabilized or the thermoplastic resins to be stabilized.

26. A process for stabilizing a halogen-containing thermoplastic resin or a mixture of two or more halogen-containing thermoplastic resins, comprising mixing the resin or resins with a stabilizing composition comprising
(a) calcium hydroxides calcium oxide or a mixture thereof,
(b) at least one hydroxyl-group-containing isocyanurate,
(c) at least one β-diketone, salt of a β-diketone or a mixture thereof,
wherein constituent (b) is present in an amount of 0.01 to 30% by weight, based on the total weight of the stabilizer composition, and wherein the weight content of constituent (c) is less than 0.3 phr, based on the thermoplastic resin to be stabilized or the thermoplastic resins to be stabilized.

27. (canceled)

28. (canceled)

29. The stabilizer composition according to claim 1, wherein the hydroxyl-group-containing isocyanurate is selected from compounds of the general formula (I) 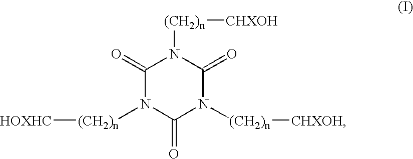
wherein the groups X and the indices n are identical or different and n is an integer of 0 to 5 and X is a hydrogen atom or a linear or branched alkyl group having 1 to 6 carbon atoms.

30. The stabilizer composition according to claim 1, further comprising a hydrotalcite or a mixture of two or more hydrotalcites.

31. The stabilizer composition according to claim 1, further comprising a mixture of zinc stearate and at least one organic zinc carboxylate.

32. The stabilizer composition according to claim 1, further comprising a triglyceride.
